(19) United States
(12) Patent Application Publication
(10) Pub. No.: US 2006/0062388 A1
(43) Pub. Date: Mar. 23, 2006

(54) System and method for command for fast I-picture rewind

(76) Inventor: Gaurav Aggarwal, Bangalore (IN)

Correspondence Address: Christopher C Winslade Esq;McANDREWS HELD & MALLOY LTD, 500 West Madison Street 34th Floor, Chicago, IL, 60661, US

(21) Appl. No.: 10/943,266

(22) Filed: Sep. 17, 2004

(51) Int. Cl. H04N 7/167

(52) U.S. Cl. 380/239

(57) ABSTRACT

Presented herein are systems, methods, and apparatus for improving performance of video decoders during rewind and fast forward operation. Video decoder performance is improved by avoiding repetitive decoding of prediction pictures. When a decoded prediction picture is stored in a frame buffer, techniques are presented for decoding multiple pictures in the rewind order which are dependent thereon, displaying the picture directly from the frame buffer, and setting one type of prediction picture as another type of prediction picture.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Television (TV) content distribution is quickly migrating from analog formats to compressed digital formats. Currently, distribution of digital video content for TV display is dominated by use of the MPEG-2 video compression standard (ISO/IEC 13818-2). MPEG-2 and its predecessor MPEG-1 define the standards to compress video content using a combination of various techniques. An MPEG-encoded stream may have three types of pictures, Intra-coded (I), Predicted (P) and Bi-directionally predicted (B). I-pictures are not compressed using any temporal predictions and can be decoded without the need of any other picture. The P-pictures perform temporal predictions from a picture that comes before it in the display order. Thus, decode of a P-pictures requires one picture (from the past) to be available with the decoder for performing temporal predictions. This prediction picture may be either an I-picture or another P-picture. The B-pictures are bi-directionally predicted and, hence, use two pictures for prediction, one from the past and another from the future (in display order).

During forward decode of MPEG streams, video decoders store the last two decompressed I/P pictures in memory. The last I/P picture is used for predicting an incoming P-picture and the last two I/P pictures are used for predicting an incoming B-picture. During a Rewind operation, the pictures have to be displayed in the reverse order. The video stream is itself fed to the decoder through a system that first recorded the stream on a recordable media such as a hard-disk. A Rewind operation is complex because B-pictures cannot be decoded from the previously decoded pictures in the rewind order. Rather, the last two prediction pictures in the forward decode order are needed by the decoder in order to decode a B-picture.

The foregoing can be accomplished by decoding only I-pictures. However, locating I pictures is complex when parsing in reverse order. Although it is possible to simply fetch batches in reverse order that are likely to include I-pictures, the batches may not necessarily begin with or end with the I-picture. Thus the decoder may decode other pictures in forward order.

Further limitations and disadvantages of conventional and traditional systems will become apparent to one of skill in the art through comparison of such systems with the invention as set forth in the remainder of the present application with reference to the drawings.

### BRIEF SUMMARY OF THE INVENTION

Presented herein is a system, method, and apparatus for a rewind playback option.

In one embodiment, there is presented a method for displaying pictures. The method comprises fetching batches of data in reverse order; decoding beginning portions of the batches of data, said portions ending with particular pictures; and displaying the particular pictures.

In another embodiment, there is presented a decoder system for displaying pictures. The decoder system comprises a direct memory access module, a video decoder, and a display engine. The direct memory access module fetches batches of data in reverse order. The video decoder decodes beginning portions of the batches of data, said portions ending with particular pictures. The display engine displays the particular pictures.

These and other advantageous and novel features as well as details of illustrated embodiments will be more fully understood from the following description and drawings.

### BRIEF DESCRIPTION OF SEVERAL VIEWS OF THE DRAWINGS

FIG. 1 is a block diagram of an exemplary circuit for displaying pictures in accordance with an embodiment of the present invention;

FIG. 2 is a block diagram of an exemplary batch;

FIG. 3 is a flow diagram for displaying pictures in accordance with an embodiment of the present invention;

FIG. 4A is a block diagram describing encoding of video data in accordance with the MPEG-2 standard;

FIG. 4B is a block diagram describing temporal compression in accordance with the MPEG-2 standard;

FIG. 4C is a block diagram describing an exemplary decode order; and

FIG. 5 is a block diagram of an exemplary decoder system in accordance with an embodiment of the present invention.

### DETAILED DESCRIPTION OF THE INVENTION

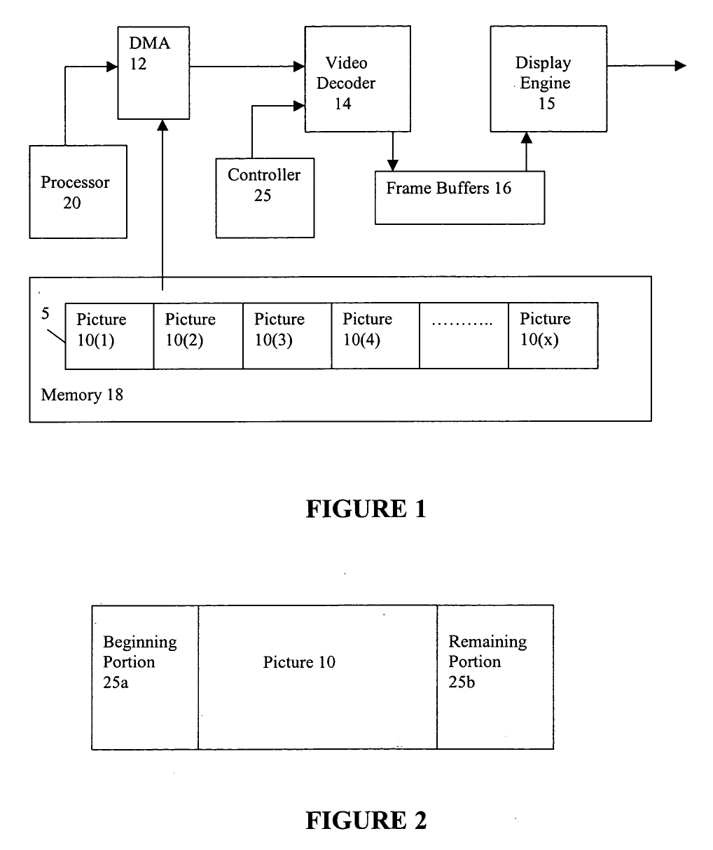

Referring now to FIG. 1, there is illustrated a block diagram describing an exemplary circuit for displaying encoded video data 5. The encoded video data 5 comprises a series of pictures 10(1) . . . 10(x) for display. The encoded video data 5 can be both compressed and encrypted.

The circuit comprises a DMA module 12, a video decoder 14, and a display engine 16. During regular playback, the DMA module 12 fetches batches of the video data 5 from a memory 18 and provides the batches of the video data 5 to the video decoder 14. The batches contain the pictures 10(1) . . . 10(x) in the decode order. The video decoder 14 decodes the pictures 10(1) . . . 10(x) in a forward decode order. The display engine 15 provides the pictures 10(1) . . . 10(x) for display in a forward display order.

It is noted, that the decoding order and display order may be different. In cases where the decoding order and the display order are different, frame buffers 16 can be used to receive the decoded pictures 10 and provide the decoded pictures to the display engine 15 in the display order.

The circuit can also display the pictures in high-speed rewind. During high-speed rewind, a portion of the pictures are displayed and in reverse order, e.g., 10(x), 10(x-3), 10(x-6), . . . . The DMA module 12 fetches batches of video data 5 that include the pictures 10 in the high-speed rewind order. However, the pictures 10 in the high-speed rewind order are not necessarily stored consecutively in the memory 18.

A processor 20 can determine address ranges of batches that include the pictures 10 in the high-speed rewind order. The processor 20 provides the address ranges to the DMA module 12. The DMA module 12 fetches the batch of video data. The video decoder 14 parses the batch starting from the beginning until the video decoder 14 detects the picture 10 in the high-speed rewind order. The video decoder 14 decodes the picture 10 in the high-speed rewind order.

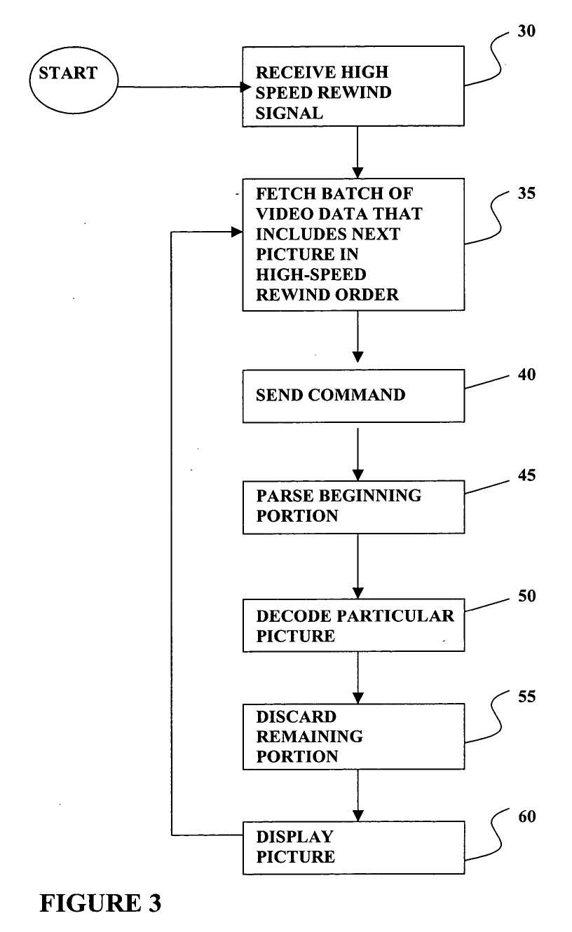

However, the batches do not necessarily begin with or end with the pictures 10 in the high-speed rewind order. FIG. 2 illustrates an exemplary batch 25. The batch 25 comprises a beginning portion 25a, a picture 10 in the high-speed rewind order, and a remaining portion 25b.

Referring again to FIG. 1, the video decoder 14 parses the beginning portions 25a of the batches of data. According to certain aspects of the invention, the video decoder 14 decodes the picture in the high-speed rewind order. Additionally, the video decoder 14 can also decrypt to picture. The display engine 15 provides the particular pictures for display.

According to certain aspects of the present invention, a controller 25 can issue a command to the video decoder 14 that is followed by the batch. The command commands the video decoder 14 to parse the beginning portion 25a, decode the picture 10 in the high-speed rewind order, and discard the remaining portion 25b of the batch.

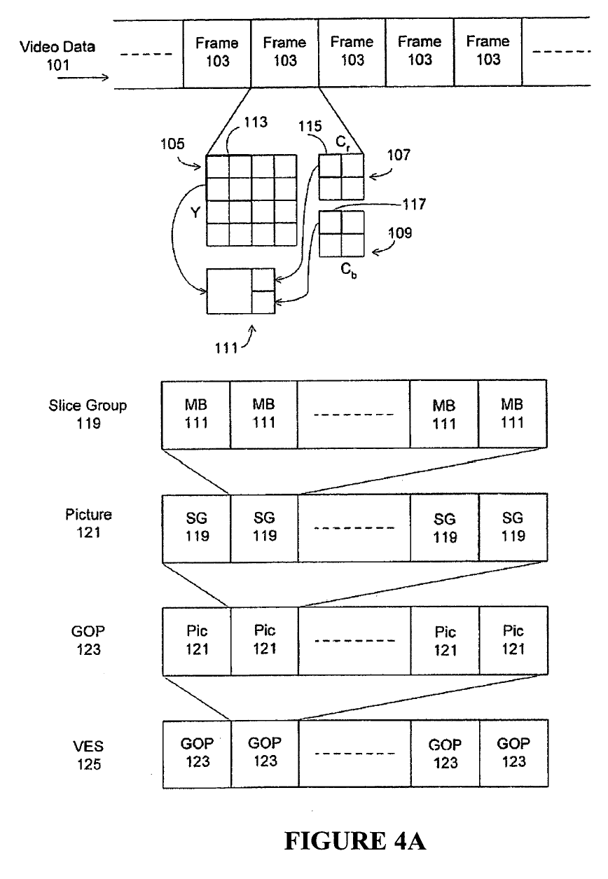

Referring now to FIG. 3, there is illustrated a flow diagram for displaying pictures in accordance with an embodiment of the present invention. At 30, the circuit receives a high-speed rewind signal. Responsive thereto, the DMA module 12 fetches (35) a batch of video data from the memory that includes the next picture in the high-speed rewind order. At 40, the controller 25 sends a command to the video decoder 14. The command is received, followed by the batch by the video decoder 14. The command causes the video decoder 45 to parse (45) the beginning portion 25a of the batch, decode the picture (50), and discard (55) the remaining portion 25b of the batch. At 60, the display engine 15 provides the decoded picture for display.

The foregoing invention will now be described in exemplary embodiments with video data encoded in accordance with the MPEG-2 standard. It will be understood that the invention is not limited to MPEG-2. In contrast, the invention can be used with a variety of encoding standards. According to certain aspects of the present invention, the high-speed rewind operation can be effectuated by displaying only intra-coded pictures in reverse order.

MPEG-2

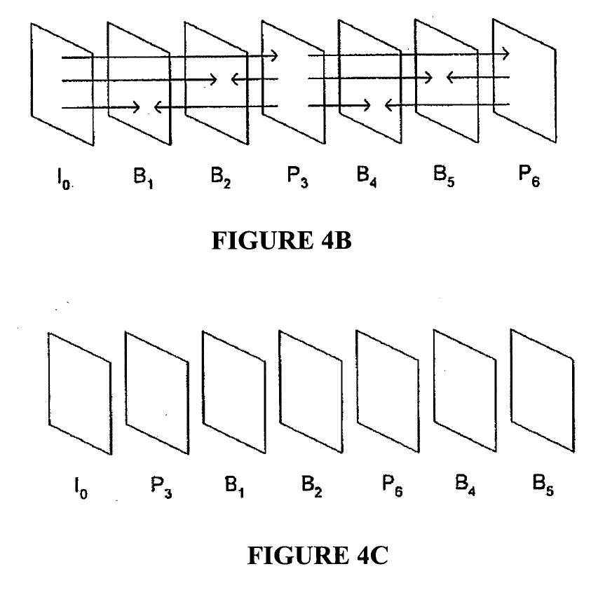

FIG. 4A illustrates a block diagram of an exemplary Moving Picture Experts Group (MPEG) encoding process of video data 101, in accordance with an embodiment of the present invention. The video data 101 comprises a series of frames 103. Each frame 103 comprises two-dimensional grids of luminance Y, 105, chrominance red Cᵣ, 107, and chrominance blue C_{b}, 109, pixels.

The two-dimensional grids are divided into 8×8 blocks, where a group of four blocks or a 16×16 block 113 of luminance pixels Y is associated with a block 115 of chrominance red Cᵣ, and a block 117 of chrominance blue C_{b} pixels. The block 113 of luminance pixels Y, along with its corresponding block 115 of chrominance red pixels Cᵣ, and block 117 of chrominance blue pixels C_{b} form a data structure known as a macroblock 111. The macroblock 111 also includes additional parameters, including motion vectors, explained hereinafter. Each macroblock 111 represents image data in a 16×16 block area of the image.

The data in the macroblocks 111 is compressed in accordance with algorithms that take advantage of temporal and spatial redundancies. For example, in a motion picture, neighboring frames 103 usually have many similarities. Motion causes an increase in the differences between frames, the difference being between corresponding pixels of the frames, which necessitate utilizing large values for the transformation from one frame to another. The differences between the frames may be reduced using motion compensation, such that the transformation from frame to frame is minimized. The idea of motion compensation is based on the fact that when an object moves across a screen, the object may appear in different positions in different frames, but the object itself does not change substantially in appearance, in the sense that the pixels comprising the object have very close values, if not the same, regardless of their position within the frame. Measuring and recording the motion as a vector can reduce the picture differences. The vector can be used during decoding to shift a macroblock 111 of one frame to the appropriate part of another frame, thus creating movement of the object. Hence, instead of encoding the new value for each pixel, a block of pixels can be grouped, and the motion vector, which determines the position of that block of pixels in another frame, is encoded.

Accordingly, most of the macroblocks 111 are compared to portions of other frames 103 (reference frames). When an appropriate (most similar, i.e. containing the same object(s)) portion of a reference frame 103 is found, the differences between the portion of the reference frame 103 and the macroblock 111 are encoded. The location of the portion in the reference frame 103 is recorded as a motion vector. The encoded difference and the motion vector form part of the data structure encoding the macroblock 111. In the MPEG-2 standard, the macroblocks 111 from one frame 103 (a predicted frame) are limited to prediction from portions of no more than two reference frames 103. It is noted that frames 103 used as a reference frame for a predicted frame 103 can be a predicted frame 103 from another reference frame 103.

The macroblocks 111 representing a frame are grouped into different slice groups 119. The slice group 119 includes the macroblocks 111, as well as additional parameters describing the slice group. Each of the slice groups 119 forming the frame form the data portion of a picture structure 121. The picture 121 includes the slice groups 119 as well as additional parameters that further define the picture 121.

I₀, B₁, B₂, P₃, B₄, B₅, P₆, B₇, B₈, P₉, in FIG. 4B, are exemplary pictures. The arrows illustrate the temporal prediction dependence of each picture. For example, picture B₂ is dependent on reference pictures I₀, and P₃. Pictures coded using temporal redundancy with respect to exclusively earlier pictures of the video sequence are known as predicted pictures (or P-pictures), for example picture P₃ is coded using reference picture I₀. Pictures coded using temporal redundancy with respect to earlier and/or later pictures of the video sequence are known as bi-directional pictures (or B-pictures), for example, pictures B₁ is coded using pictures I₀ and P₃. Pictures not coded using temporal redundancy are known as I-pictures, for example I₀. In the MPEG-2 standard, I-pictures and P-pictures are also referred to as reference pictures.

The foregoing data dependency among the pictures requires decoding of certain pictures prior to others. Additionally, the use of later pictures as reference pictures for previous pictures requires that the later picture is decoded prior to the previous picture. As a result, the pictures cannot be decoded in temporal display order, i.e. the pictures may be decoded in a different order than the order in which they will be displayed on the screen. Accordingly, the pictures are transmitted in data dependent order, and the decoder reorders the pictures for presentation after decoding. I₀, P₃, B₁, B₂, P₆, B₄, B₅, P₉, B₆, B₇, in FIG. 4C, represent the pictures in data dependent and decoding order, different from the display order seen in FIG. 4B.

Referring again to FIG. 4A, the pictures are then grouped together as a group of pictures (GOP) 123. The GOP 123 also includes additional parameters further describing the GOP. Groups of pictures 123 are then stored, forming what is known as a video elementary stream (VES) 125. The VES 125 is then packetized to form a packetized elementary sequence. The packetized elementary stream includes parameters, such as the decode time stamp and the presentation time stamp. The packetized elementary stream is then further packetized into fixed length packets, each of which are associated with a transport header, forming what are known as transport packets. The packetized elementary stream can also be encrypted.

The transport packets can be multiplexed with other transport packets carrying other content, such as another video elementary stream 125 or an audio elementary stream. The multiplexed transport packets form what is known as a transport stream. The transport stream is transmitted over a communication medium for decoding and displaying.

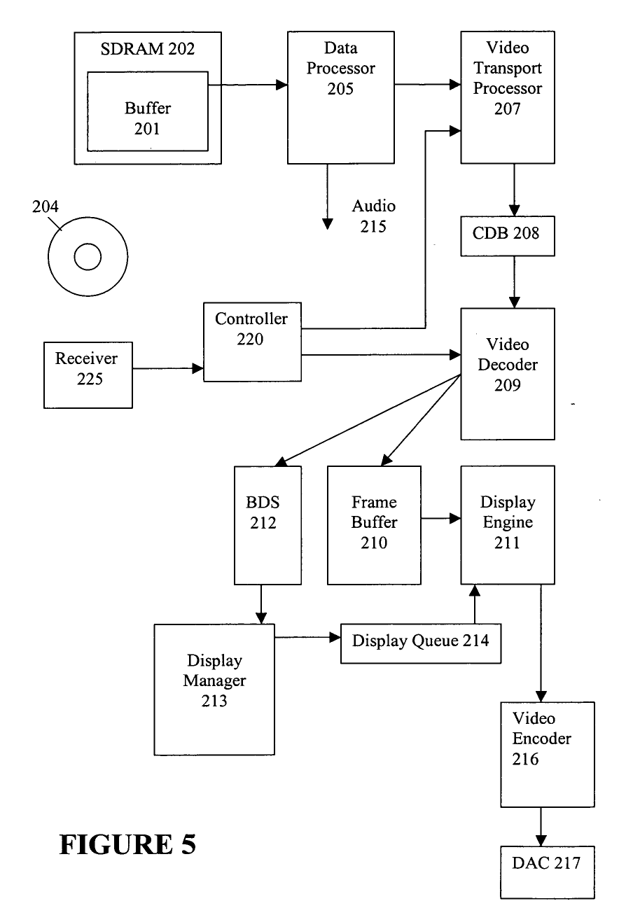

Referring now to FIG. 5, there is illustrated a block diagram of an exemplary circuit for decoding the compressed video data, in accordance with an embodiment of the present invention. A buffer 201 within a Synchronous Dynamic Random Access Memory (SDRAM) 202 receives a transport stream. The buffer 201 can receive the transport stream, either from a storage device 204, such. as, for example, a hard disc or a DVD, or a communication channel 206.

A data transport processor 205 demultiplexes the transport stream into audio transport streams and video transport streams. The data transport processor 205 provides the audio transport stream to an audio portion 215 and the video transport stream to a video transport processor 207. The video transport processor 207 parses the video transport stream and recovers the video elementary stream. The video transport processor 207 writes the video elementary stream to a compressed data buffer 208. A video decoder 209 reads the video elementary stream from the compressed data buffer 208 and decodes the video. The video decoder 209 decodes the video on a picture by picture basis. When the video decoder 209 decodes a picture, the video decoder 209 writes the picture to a frame buffer 210.

The video decoder 209 receives the pictures in decoding order. However, as noted above, the decoding and displaying orders can be different. Accordingly, the decoded pictures are stored in frame buffers 210 to be available at display time. At display time, display engine 211 scales the video picture, renders the graphics, and constructs the complete display. Once the display is ready to be presented, it is passed to a video encoder 216 where it is converted to analog video using an internal digital to analog converter (DAC). The digital audio is converted to analog in an audio digital to analog converter (DAC) 217.

The frame buffers 210 also allow the video decoder 209 to predict predicted pictures from reference pictures. The decoder 209 decodes at least one picture, I₀, B₁, B₂, P₃, B₄, B₅, P₆, B₇, B₈, P₉, during each frame display period, in the absence of Personal Video Recording (PVR) modes when live decoding is turned on. Due to the presence of the B-pictures, B₁, B₂, the decoder 209 decodes the pictures, I₀, B₁, B₂, P₃, B₄, B₅, P₆, B₇, B₈, P₉ in an order that is different from the display order. The decoder 209 decodes each of the reference pictures, e.g., I₀, P₃, prior to each picture that is predicted from the reference picture. For example, the decoder 209 decodes I₀, B₁, B₂, P₃, in the order, I₀, P₃, B₁, and B₂. After decoding I₀ and P₃, the decoder 209 applies the offsets and displacements stored in B₁ and B₂, to the decoded I₀ and P₃, to decode B₁, and B₂. The frame buffers 210 store the decoded pictures, I₀ and P₃, in order for the video decoder 209 to decode B₁ and B₂ .

The video decoder 209 also writes a number of parameters associated with each picture in a buffer descriptor structure 212. Each frame buffer 210 is associated with a buffer descriptor structure 212. The buffer descriptor structure 212 associated with a frame buffer 210 stores parameters associated with the picture stored in the frame buffer 210. The parameters can include, for example presentation time stamps.

A display manager 213 examines the buffer descriptor structures, and on the basis of the information therein, determines the display order for the pictures. The display manager 213 maintains a display queue 214. The display queue 214 includes identifiers identifying the frame buffers 210 storing the pictures to be displayed. The display engine 211 examines the display queue 214 to determine the next picture to be displayed.

The display manager 213 can determine the next picture to be displayed by examining the PTS parameters associated with the pictures. The display manager 213 can compare the PTS values associated with pictures to a system clock reference (SCR) to determine the ordering of the pictures for display.

Alternatively, the display manager 213 can also determine the order of the pictures to be displayed by examining the type of pictures decoded. In general, when the video decoder 209 decodes a B-picture, the B-picture is the next picture to be displayed. When the video decoder 209 decodes an I-picture or P-picture, the display manager 213 selects the I-picture or P-picture that was most recently stored in the frame buffer 210 to be displayed next.

A particular one of the frame buffers 210 stores B-pictures, while two other frame buffers 210 store I-pictures and P-pictures. When the video decoder 209 decodes a B-picture, the video decoder 209 writes the B-picture to the particular frame buffer 210 for storing B-pictures, thereby overwriting the previously stored B-picture. When the video decoder 209 decodes an I-picture or a P-picture, the video decoder 209 writes the I-picture or P-picture to the frame buffer 210 storing the I-picture or P-picture that has been stored for the longest period of time, thereby overwriting the I-picture or P-picture.

The circuit also includes a controller 220 that acts as the master for the data transport processor 205, the video transport processor 207, the video decoder 209, the display engine 211, and the display manager 213.

The circuit also supports a number of functions allowing the user to control the presentation of the video. These functions include high-speed rewind. In high-speed rewind, the circuit provides the pictures of a video elementary stream for display in reverse order. When the pictures are displayed in reverse order, the video appears in reverse and faster. The video appears faster because the circuit provides only the I-pictures for display.

The high-speed rewind is initiated by a receipt of a user signal by receiver 225. Upon receiving the signal, the receiver 225 notifies the controller 220. The controller 220 then issues commands to the video transport processor 207, the video decoder 209, and the display engine 211, that perform the high-speed rewind operation. According to certain aspects of the present invention, the commands can be provided in transport packets.

During the high-speed rewind operation, the video transport processor 207 fetches batches of data from the SDRAM in reverse order via a DMA module 208. The video transport processor 207 can determine the address ranges for the batches by examining the transport packets. The transport packets include a parameter identifying pictures in terms of what are known as access units. Based on the number of transport packets between access units, the video transport processor 207 can determine the address ranges for batches that include I-pictures.

Each batch includes the next I-picture for display in the high-speed rewind order. The video decoder 209 parses the beginning portions of the batches of data, decodes the I-picture, and discards the remaining portion of the batch. The display engine 211 provides the I-picture for display.

The circuit as described herein may be implemented as a board level product, as a single chip, application specific integrated circuit (ASIC), or with varying levels of the system integrated on a single chip with other portions of the system as separate components. The degree of integration of the monitoring system may primarily be determined by speed of incoming MPEG packets, and cost considerations. Because of the sophisticated nature of modern processors, it is possible to utilize a commercially available processor, which may be implemented external to an ASIC implementation of the present system. Alternatively, if the processor is available as an ASIC core or logic block, then the commercially available processor can be implemented as part of an ASIC device wherein the memory storing instructions is implemented as firmware.

While the invention has been described with reference to certain embodiments, it will be understood by those skilled in the art that various changes may be made and equivalents may be substituted without departing from the scope of the invention. In addition, many modifications may be made to adapt particular situation or material to the teachings of the invention without departing from its scope. Therefore, it is intended that the invention not be limited to the particular embodiment(s) disclosed, but that the invention will include all embodiments falling within the scope of the appended claims.

1. A method for displaying pictures, said method comprising:
fetching batches of data in reverse order;
parsing beginning portions of the batches of data, said beginning portions ending at particular pictures; and
displaying the particular pictures.

2. The method of claim 1, further comprising:
transmitting commands, said commands for parsing the beginning portions of the batches of data.

3. The method of claim 2, wherein the commands form a portion of a transport packet.

4. The method of claim 1, wherein the particular pictures comprise intra-coded pictures.

5. The method of claim 1, further comprising:
receiving a rewind command.

6. The method of claim 1, further comprising:
decoding the particular pictures.

7. The method of claim 6, further comprising:
discarding portions of the batch that are subsequent to the particular pictures.

8. The method of claim 1, wherein the batches comprise encrypted data, said method further comprising:
decrypting the beginning portions of the batches.

9. A decoder system for displaying pictures, said decoder system comprising:
a direct memory access module for fetching batches of data in reverse order;
a video decoder for parsing beginning portions of the batches of data, said portions ending at particular pictures; and
a display engine for displaying the particular pictures.

10. The decoder system of claim 9, further comprising:
a controller for transmitting commands, said commands for decoding the beginning portions of the batches of data.

11. The decoder system of claim 10, wherein the commands form a portion of a transport packet.

12. The decoder system of claim 9, wherein the particular pictures comprise intra-coded pictures.

13. The decoder system of claim 9, further comprising:
a receiver for receiving a rewind command.

14. The decoder system of claim 9, wherein the video decoder discards remaining portions of the batches, the remaining portions being subsequent to the particular picture in the batch.

15. The decoder system of claim 14, wherein the video decoder decodes the particular pictures.

16. The decoder system of claim 9, wherein the batches comprise encrypted data, and wherein the decoder decrypts the beginning portions of the batches.
